(19) United States
(12) Patent Application Publication
(10) Pub. No.: US 2026/0119125 A1
(43) Pub. Date: Apr. 30, 2026

(54) APPLICATION DEPENDENCY INSIGHT ENGINE

(71) Applicant: Truist Bank, Charlotte, NC (US)

(72) Inventor: Kimberley Tatem, Atlanta, GA (US)

(73) Assignee: Truist Bank, Charlotte, NC (US)

(21) Appl. No.: 18/932,880

(22) Filed: Oct. 31, 2024

(51) Int. Cl. G06F 8/20; G06F 8/65

(52) U.S. Cl. CPC G06F 8/20; G06F 8/65

(57) ABSTRACT

A computer implemented method includes identifying a first application and identifying trickle linkages between the first application and each of one or more linked application. The method also includes outputting a presentation on a user interface of the first application and each of the one or more linked applications. The method also includes receiving a request to update an element of the first application. The method also includes updating the presentation of the first application and the trickle linkages based at least in part on the request and updating the first application and the one or more linked applications based at least in part on the updated presentation

### TECHNICAL FIELD

The present disclosure relates generally to assessment of systems with interconnected components. More specifically, but not by way of limitation, this disclosure relates to systems and methods that may leverage techniques to detect the impact of a potential change on a system prior to the change being made.

### BACKGROUND

Modern enterprise environments may be complex systems that may include interdependent applications, microservices, and infrastructure components. These systems may collectively support critical business operations. In part due to the complexity, these environments are particularly prone to instability when updates or changes are made, such as software upgrades, certificate renewals, or server patches. Often, such changes can inadvertently disrupt operations if other interconnected components (e.g., applications, microservices) are not examined in advance. Such disruptions can have significant impacts, particularly in fields like finance, healthcare, and manufacturing, where system stability is needed.

### SUMMARY

Various aspects of the present disclosure provide a system and methods for estimating the impact of a potential update or change to one or more components (e.g., files, applications, configurations, certificates, server settings) within an enterprise environment.

In an example, a computing device includes a processor and a non-transitory computer-readable medium including instructions that are executable by the processor for causing the processor to identify a first application and identify trickle linkages between the first application and each of one or more linked applications. The instructions can further cause the processor to output a presentation on a user interface of the first application and each of the one or more linked applications. The instructions can further cause the processor to receive a request to update an element of the first application. The instructions can further cause the processor to update the presentation of the first application and the trickle linkages based at least in part on the request and update the first application and the one or more linked applications based at least in part on the updated presentation.

In an additional example, a computer implemented method includes identifying a first application and identifying trickle linkages between the first application and each of one or more linked application. The method also includes outputting a presentation on a user interface of the first application and each of the one or more linked applications. The method also includes receiving a request to update an element of the first application. The method also includes updating the presentation of the first application and the trickle linkages based at least in part on the request and updating the first application and the one or more linked applications based at least in part on the updated presentation

In an additional example, a non-transitory computer-readable medium may include instructions that are executable by a processing device for causing the processing device to identify a first application and identify trickle linkages between the first application and each of one or more linked applications. The instructions can further cause the processor to output a presentation on a user interface of the first application and each of the one or more linked applications. The instructions can further cause the processor to receive a request to update an element of the first application. The instructions can further cause the processor to update the presentation of the first application and the trickle linkages based at least in part on the request and update the first application and the one or more linked applications based at least in part on the updated presentation.

### BRIEF DESCRIPTION OF THE DRAWINGS

FIG. 1 is an example illustrative of a system according to some embodiments of the present disclosure.

FIG. 2 is a block diagram of an example computing device according to some embodiments of the present disclosure.

FIG. 3 is a flowchart of an example of a process for implementing some aspects of the present disclosure.

### DETAILED DESCRIPTION

Certain aspects and examples of the present disclosure relate to methods and systems to address the complexity of managing interconnected applications within an enterprise environment. As an example, managing interconnected applications might include specific procedures for ensuring that an email application can seamlessly update a calendar application with event details. The disclosed technology addresses challenges in determining environment stability when changes made to one application may have downstream effects. The technology is particularly useful in complex environments like financial institutions, payment systems, secure computing environments, etc., where production systems may be highly interdependent, and interruptions can have widespread consequences.

The disclosed technology may offer advantages in managing updates in an enterprise environment. One aspect of the disclosed technology is the ability to proactively assess risks by predicting the result of modifying an application and considering the trickle linkage of related applications and corresponding changes to the related applications. By considering an application and its linkages, i.e., applications linked to or from an application, the system can predict impacts of future changes. Another aspect of the disclosed technology is providing an understanding of how applications within an environment are interconnected. A dependency mapping may include details to allow information about one application to be analyzed for its effects on all related applications. This may in turn allow for creating a more resilient and robust environment. The technology's automated dependency mapping allows the system to evaluate how changes to one application may affect others, reducing the need for manual oversight and enabling more informed decision-making.

The disclosed technology may include a dynamic dashboard that allows for visualization of the impact of a change in an enterprise environment. In some examples, the impact of a change or a potential change to the system may be visualized in real-time, enhancing operational visibility and allowing operators of a system to monitor ongoing changes. The disclosed technology may include an API that can query for impact severity of a change. This may enable integration with deployment workflows. Further, automated alerts and notification systems may be supported by the disclosed technology to ensure that affected teams are informed and that critical dependencies are maintained when changes are being made. The disclosed technology may enable external systems to retrieve impact assessments and make informed decisions based on real-time data. For example, when updates to infrastructure components (e.g., certificate renewals, server updates, etc.) occur, they may impact multiple applications if not carefully managed. The technology may account for these multiple dependencies by representing elements as nodes within a dependency graph, allowing the technology to analyze or mitigate the risk associated with their updates.

Conventional methods for understanding the application interdependencies are often cumbersome, inefficient, lacking, or some combination thereof. Typically, these enterprise environments include numerous applications and services that rely on each other to function correctly. For instance, a simple certificate upgrade in one application might lead to unexpected downtime in multiple other applications if these applications were not properly informed. This may lead to a challenge regarding the inability to fully assess the impact of a change before it is implemented. The complexity of determining the impact of a change further makes it difficult for administrators or managers of a system to determine how to assess the impact on a live enterprise environment prior to making a necessary change (e.g., an update to a security certificate).

The present disclosure provides a high-level interactive visual representation of how different applications are related, both upstream and downstream, thereby significantly enhancing the efficiency and effectiveness of managing these interdependencies. To illustrate, an application dependency insights engine can be presented that features a central object representing the primary application of interest, surrounded by peripheral objects that denote connected applications. This structure enables a user to select any peripheral object to shift focus, making the selected object the new central object and displaying its interdependencies. In an example, a computing device includes a processor and a non-transitory computer-readable medium including instructions that are executable by the processor for causing the processor to identify a first application and identify trickle linkages between the first application and each of one or more linked applications. The processor can output a presentation on a user interface of the first application and each of the one or more linked applications. The processor may receive a request to update an element of the first application and update the presentation accordingly including updating the presentation of the first application as well as the trickle linkages based on the request to update an element of the first application. Additionally, the processor can implement the request by updating the first application and the one or more linked applications based on the updated presentation or based on the request to update an element of the first application.

Embodiments of the present disclosure include an ability to assess the impact of changes across applications. By visualizing the interdependencies, operators can quickly determine the potential ripple effects of a change in one application on other trickle linked applications. Advantages of the present disclosure includes tools for facilitating better planning and decision making. Additionally, according to some examples, a tool can incorporate a traffic light system (red, yellow, green) to indicate the ease of implementing changes to an application. This system provides a quick visual cue about the complexity and potential risks associated with changes to an application and, further, in implementing the changes.

Additional advantages include the ability to visualize how data privatization impacts a system and its connected applications and to help teams anticipate and mitigate issues. This capability is particularly beneficial for project managers who need to coordinate changes across multiple applications, ensuring that all affected teams are informed and prepared for upcoming changes. By enhancing collaboration and reducing the likelihood of unforeseen problems, the visualization tool can be an invaluable asset in enterprise project management. Further, the embodiments described herein allow for compatibility and real-time accuracy by dynamically identifying interdependencies between applications. These advancements in visualizing and managing application interdependencies improves decision-making, efficiency, and reduces the risk of disruptions caused by changes to interconnected applications.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

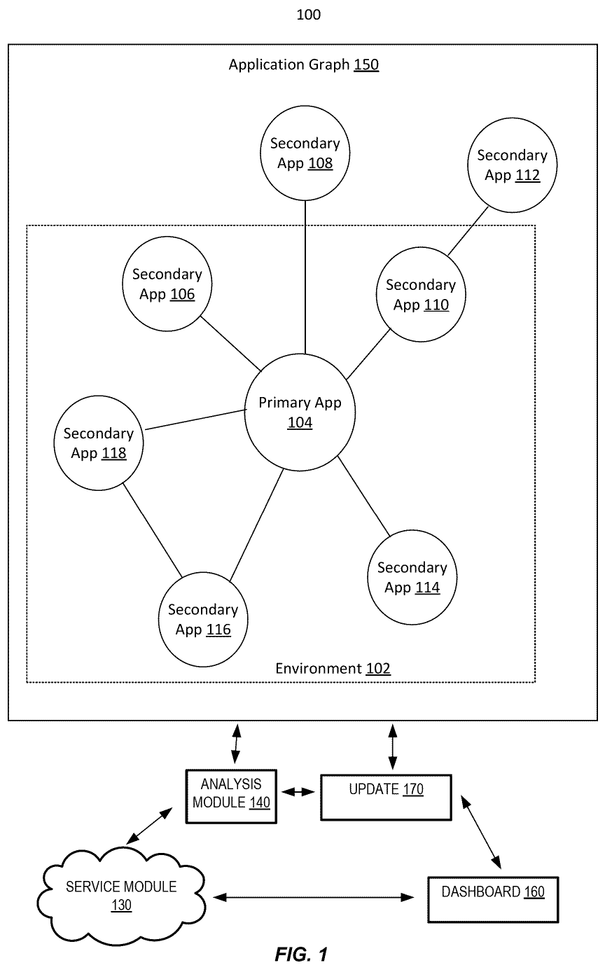

FIG. 1 illustrates an overview of an environment stability assessment architecture, according to some aspects of the present disclosure. Illustrated in FIG. 1 is an architecture 100 that may be configured to analyze the impact of changes in an environment, such as an enterprise environment. The architecture 100 includes an environment 102, primary application 104, secondary applications 106-118, application graph 150, service module 130, analysis module 140, dashboard 160, and update 170. A user may interact with a system using a user interface that communicates with architecture 100. As further explained below, these components may interact with one another to gather, process, analyze, and visualize data related to changes within the environment 102, and may provide an assessment of stability risks associated with changes to the environment 102.

Architecture 100 may be used to monitor and implement changes that occur within the environment 102. Architecture 100 may be used to map out dependencies between applications. The dependencies may be used to identify linkages between applications and identify areas where changes to one application (or other system component) might propagate through interconnected services (i.e., trickle linkage). This approach may allow for proactive risk management, as the system can help operators evaluate the stability of the environment 102 before, during, and after changes are implemented. Through real-time visualization on the dashboard 160, operators may gain insight into which applications are impacted by changes and assess the overall stability status of the environment 102. This information can then guide decision-making, reducing the likelihood of unforeseen disruptions.

The service module 130 may function as a platform for managing and processing change updates between applications with an association within the environment 102. An association, or link, between applications can be any connection with data flowing between two or more applications. Data about the linkage between applications can be received by service module 130 which may handle a combination of automated data collection, integration from multiple data sources, and manual input from teams involved in managing these applications. For example, an API endpoint might return a list of other applications the primary application interacts with, the type of data exchanged, and the nature of the interaction (e.g., real-time, batch processing). Links can be identified with the primary application 104 and applications within the environment 102, such as secondary application 106, but may also include links between the primary application 104 and applications outside the environment 102, such as secondary applications 108, 112. A linkage does not need to be direct. As illustrated, secondary application 112 is linked to primary application 104 through secondary application 110. In another example, interdependencies between secondary applications may be shown, such as the link between secondary application 116 and secondary application 118.

Analysis module 140 may serve as a component for predicting updates 170 and assessing potential stability risks within the environment 102. An update 170 may represent changes, modifications, or adjustments within the environment 102. For example, update 170 may include software version changes, configuration adjustments, or scheduled maintenance activities. Each update may impact one or more applications and influence the dependencies within the application graph 150.

When an update 170 is received, the analysis module may determine its scope by identifying the source application and any directly or indirectly affected applications. The determination may involve recalculating the weights associated with affected nodes, based on factors such as the criticality of the update, the number of impacted downstream services, and the tier level of the application being changed or updated. For instance, an update that alters a core configuration setting within a high-tier application may have a more significant weight than a routine maintenance update in a lower-tier application. The analysis module 140 may assess updates 170 for potential ripple effects across the environment 102. By leveraging the application graph 150, the module can trace the interdependencies from the source node of the update to its dependent nodes, evaluating how far-reaching the update's impacts may be. This assessment may allow the system to anticipate indirect consequences, helping operators make more informed decisions before deploying the update. If the analysis module 140 identifies a high-risk update, the analysis module 140 may trigger alerts or suggest scheduling changes to reduce potential disruptions.

The analysis model 140 may evaluate the update 170 and process data about the interdependencies between applications to predict how a change to one application will affect the other, linked applications. The analysis module 140 may be used to first generate a mathematical structure (e.g., a graph, a directed graph) to explain the interconnected of various applications or other components within the enterprise environment 102. This may be based on information obtained from a service module, configuration files, or other information. Thereafter, analysis module 140 may update and refine the understanding of application relationships and dependencies within the enterprise environment 102. As illustrated in FIG. 1, the relationships and dependencies within the enterprise environment 102 may include considering relationships and dependencies to and from application outside of the enterprise environment 102 such as the secondary applications 108 and 112. Thus, the architecture 100 can provide a wholistic view of interdependencies between applications in the enterprise environment 102.

According to some embodiments, the analysis module 140 may perform dependency impact simulation. For example, before implementing a change, the analysis module 140 may be used to simulate the effects of the change across the application graph 150. Thus, the impact may be visualized (e.g., the impact on various interconnected nodes). Such a simulation may be useful in environments where certain changes have the potential to trigger cascading changes. By simulating these impacts, operators of the environment may identify high-risk scenarios and adjust their deployment strategies accordingly.

In some examples, the analysis module 140 might have adaptive learning capabilities, allowing the analysis module 140 to improve its predictions over time. As new changes to applications are processed, the module may refine its weighting algorithms based on observed outcomes, such as update resolution times and the effectiveness of mitigation strategies. This adaptive approach may help the system more accurately predict the potential impact of future changes and support more nuanced decision-making.

The analysis module 140 may also facilitate real-time updates to the application graph 150, ensuring that the analysis module 140 accurately reflects the current state of the environment. This dynamic updating process may involve recalculating weights and dependencies whenever a new change is logged, ensuring that operators have access to up-to-date stability assessments. Additionally, the analysis module may trigger alerts or cause messages to be transmitted to the dashboard 160 when specific conditions are met, such as when an application's weight surpasses a predefined threshold, indicating a heightened risk to the environment. In this manner, the analysis module 140 may act as an intelligent assessment engine within the environment stability assessment system 100, providing operators with actionable insights into how changes may affect the broader landscape.

The application graph 150 may serve as a dynamic, visual representation of an environment 102, including the most recent configuration of the environment. The application graph 150 may be a mathematical construct (e.g., a mathematically defined graph with vertices and edges). The application graph 150 may be a directed or undirected graph. Each node on the application graph 150 may represent an application (labeled secondary applications 106-118), component, microservice, configuration file, or other functional element within the environment 102. Although illustrated as a graph, equivalent mathematical representations of the graph may be used by the architecture 100. For example, the application graph 150 may be defined as a set of vertices and edges. In some examples, the graph may be cyclical. In this case, algorithms may be used to detect that the graph is cyclical, and certain edges (e.g., edges with a low impact on the overall environment) may be removed to avoid the cyclical graph and to ensure that the computation of a singular change is not computed in a cyclical manner. In some examples, the application graph 150 may be referred to as a dependency graph. The application graph 150 may be weighted based on historical incidences. The application graph 150 may be unweighted when created only from a configuration file (e.g., only representing the relationships between the nodes).

The application graph 150 may illustrate or allow for a visualization of the interdependencies between various applications. Each application in the environment may be represented as a node (labeled primary application 104 and secondary applications 106-118), while the edges connecting nodes may indicate dependencies between these applications. For instance, a node representing a centralized payment service may have edges connecting the centralized payment service to other nodes that represent dependent services, such as database servers, authentication modules, or customer-facing applications. The application graph 150 may therefore provide operators with a clear view of how changes in one application might ripple through the network, affecting multiple interconnected services. The application graph 150 may continuously update based on data processed by the analysis module 140. For example, update 170 may cause a change to the enterprise environment 102, in change causing a change to the application graph. This dynamic updating ensures that the graph remains an accurate reflection of the current state of the environment. The graph might also adjust existing connections if the underlying architecture changes, such as when applications are added, removed, or reconfigured. As illustrated in FIG. 1, the application graph 150 can present a visualization of a how a change to primary application 104 will impact secondary applications 106-118.

In addition to illustrating dependencies, the application graph 150 may also include weighted nodes, where each weight reflects or is related to the impact potential of an application it represents. These weights might be visually represented by varying node sizes or colors in the dashboard 160, helping operators quickly identify high-impact applications. For example, nodes with higher weights may appear larger or in a distinct color, signifying that changes to these applications may have significant consequences for the environment 102. This visual distinction may allow operators to quickly assess the areas of greatest concern during stability evaluations. The application graph 150 may further support advanced filtering and customization options, allowing operators to focus on specific tiers, updates, or application groups. For instance, an operator might filter the graph to display only tier-one applications, which represent the most critical services within the environment. Alternatively, the operator may isolate nodes affected by recent changes, providing a focused view of the areas currently under scrutiny.

To enhance decision-making, the application graph 150 might also support live interaction with other components of the system. For example, an operator may select a node within the graph to view additional details about the corresponding application, such specific dependencies. This interactive capability may streamline the process of assessing the potential impact of changes, as operators can access relevant information directly from the graph interface. Additionally, by integrating with the dashboard 160, the application graph 150 may provide visual indicators of ongoing changes, such as color-coded status markers that update are resolved or validated. In this manner, the application graph 150 may function as a comprehensive map of the environment's 102 interdependencies, helping environmental operators manage and assess the stability of interconnected applications with greater accuracy and efficiency.

The dashboard 160 may function as a visualization or control interface, offering real-time insights into the status of applications within the environment 102. Dashboard 160 may display a comprehensive view of the application graph 150, allowing operators to monitor the health and stability of interconnected applications. The dashboard 160 might present data in an intuitive format, such as color-coded nodes and visual alerts, enabling operators to quickly identify areas of concern and take corrective actions as needed. In some examples, different types of nodes (microservices, applications, etc.) may be sized, shaped, or colored differently to understand the impact of the same.

According to some embodiments, architecture 100 may incorporate a traffic light system to indicate the ease of making changes to an application. The traffic light system can provide a quick visual que about the complexity and potential risk associated with a potential changes. The dashboard 160 may also include a color-coded status system to reflect the potential stability of each node for each change. For example, nodes that may be harder to change might be marked in yellow, while those that may be easier to change may appear in green. In cases where a change can negatively affect a node, the dashboard might display the node in red, signaling a high-priority issue that requires greater attention. These color indicators may update in real-time as the system processes change predictions, change requests, and validations, providing operators with an up-to-the-minute view of the environment's 102 status.

The dashboard 160 might also integrate with other components of the system, such as the analysis module 140 and the application graph 150, to support live interaction and data retrieval. For instance, when a new change request is submitted, the dashboard may automatically display the predicted impact on connected nodes, allowing operators to assess the potential consequences before implementing the change. The dashboard may further support “what-if” scenarios by enabling operators to simulate changes and observe potential impacts on the graph. This capability may assist in planning and risk management, as operators can proactively evaluate various deployment strategies and their implications. The dashboard 160 may feature alerting and notification capabilities to ensure that relevant users, operators, or entities are informed about ongoing changes. The system may be configured to send automated alerts to users or entities associated with applications affected by a particular change. As an example, the alerts may include key details such as the update source, affected nodes, and estimated resolution time, helping teams prepare for potential disruptions. Additionally, the dashboard 160 may log all alerts and notifications, maintaining an audit trail that may be used for post-change review and analysis. To support long-term stability assessments, the dashboard 160 might also offer reporting functions that aggregate data over time, providing insights into recurring issues and trends.

Analysis module 140 may employ any suitable algorithm to determine the application graph 150 or other aspects of the environment 102. This may include machine learning models, neural networks, and other adaptive algorithms. As one example, the analysis module 140 may utilize a weighted dependency impact algorithm to determine the severity of updates based on the relationships within the application graph 150. This algorithm may analyze the network of nodes and edges to assess risks associated with specific updates, factoring in the tier level of affected nodes, the number of downstream dependencies, and any concurrent changes. In some examples, the analysis module may read a configuration management database (CMDB) data and create a neural network for every application. Thus, the analysis module 140 may generate multiple neural networks. Each neural network may be interlinked with a neural network for each other application. Alternatively, a neural network may be created for the application alone. The neural network may be used to determine an impact when the analysis module 140 determines that a change may directly impact a specific application (e.g., based on the CMDB, other configuration files, or other information). Within a neural network, each application may act as a node of the application, and the weight of the node may be calculated based on the tier of the application and the number of downstream application impacts. The weights and training of the neural network may be based on historical information and training, and the neural network may be periodically trained and updated over time.

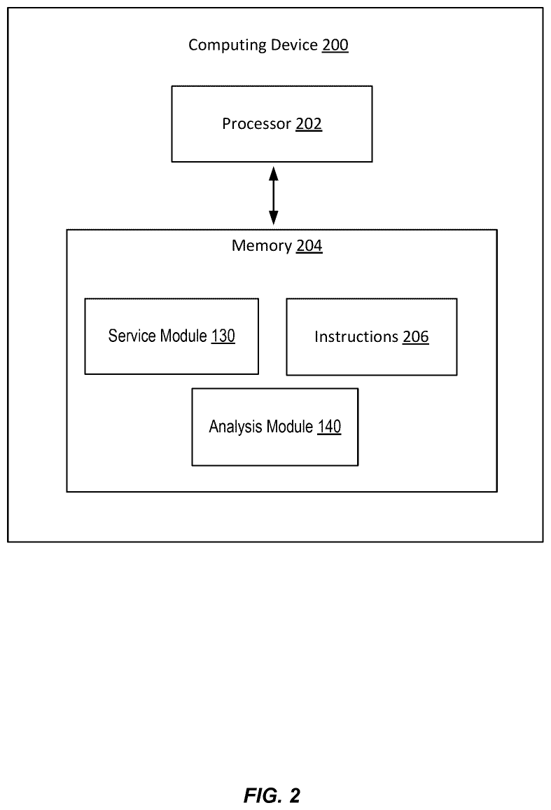

FIG. 2 is a block diagram of a computing device 200 according to some embodiments of the present disclosure. The computing device 200 includes a processor 202 that is communicatively coupled to a memory 204. In some examples, the processor 202 and the memory 204 may be distributed from (e.g., remote to) one another.

The processor 202 can include one processing device or multiple processing devices. Non-limiting examples of the processor 202 include a Field-Programmable Gate Array (FPGA), an application-specific integrated circuit (ASIC), a microprocessor, etc. The processor 202 can execute instructions 206 stored in the memory 204 to perform operations. In some examples, the instructions 206 can include processor-specific instructions generated by a compiler or an interpreter from code written in a suitable computer-programming language, such as C, C++, C#, etc.

The memory 204 can include one memory or multiple memories. The memory 204 can be non-volatile and may include any type of memory that retains stored information when powered off. Non-limiting examples of the memory 204 include electrically erasable and programmable read-only memory (EEPROM), flash memory, or any other type of non-volatile memory. At least some of the memory 204 can include a non-transitory, computer-readable medium from which the processor 202 can read instructions 206. A computer-readable medium can include electronic, optical, magnetic, or other storage devices capable of providing the processor 202 with computer-readable instructions or other program codes. Non-limiting examples of a computer-readable medium include magnetic disk(s), memory chip(s), read-only memory (ROM), random-access memory (RAM), an ASIC, a configured processor, optical storage, or any other medium from which a computer processor can read the instructions 206. The memory also may include one or more modules, files, or instructions described above with respect to FIG. 1, including for example, service module 130 and analysis module 140.

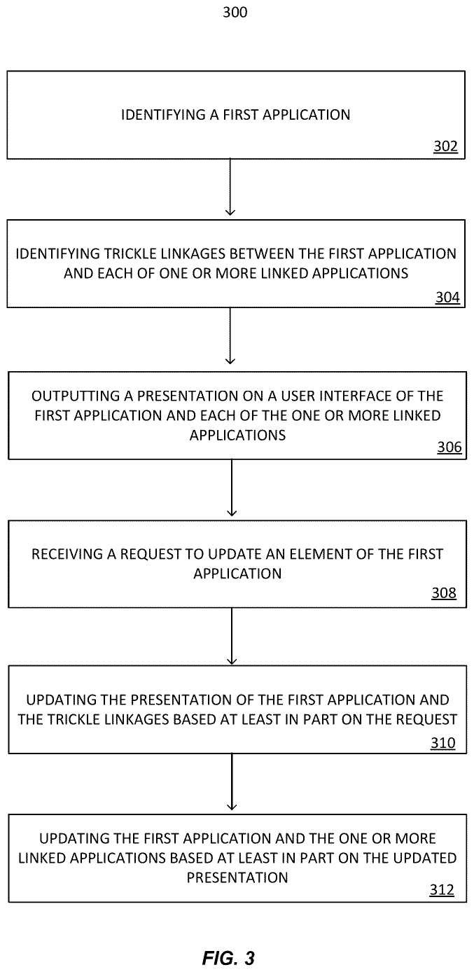

FIG. 3 is a flowchart showing estimating and implementing the impact of an update to an environment based on known dependencies within the environment, according to some aspects of the present disclosure. Illustrated in FIG. 3 is method 300. Method 300 may may be used for model training and data preprocessing, according to some aspects of the present disclosure. One or more computing devices depicted in FIG. 2 may implement operations by executing suitable program code (e.g., the analysis module 140). For illustrative purposes, the method 300 is described with reference to certain examples depicted in the figures. Other implementations, however, are possible. While the blocks of the method 300 are described in the temporal order below for illustrative purposes, it may be appreciated that the blocks can occur in any order and some blocks may occur simultaneously.

At block 302, a first application is identified. For example, an operator may select an application using dashboard 160 to be the focal, or primary application for purposes of evaluating and implementing changes to the first application and interconnected applications. The selection may be from a presentation of the application graph 150. The application graph 150 may support advanced filtering and customization options, allowing operators to focus on specific tiers, updates, or application groups. For instance, an operator might filter the graph to display only tier-one applications, which represent the most critical services within the environment. Alternatively, the operator may isolate nodes affected by recent changes, providing a focused view of the areas currently under scrutiny. The filters can aid the operator in selecting the first application to be identified.

At block 304, the trickle linkages between the first application and each of one or more linked applications is identified. This may include mapping between affected applications or all applications within a neural network. This step may utilize a CMDB file. The generated map may be used to create a neural network for each node or application within the generated map. The map may be similar to the application graph 150. In some examples, the analysis module 140 may be used to create a dependency that may be represented by the application graph 150. Each application of the application graph 150 may be represented as a node, and dependencies may be shown as edges (which may illustrate how updates might propagate through the environment). This dependency mapping provides a visual structure that helps operators understand how interconnected applications are affected by changes, forming the basis for risk assessment and impact prediction. Additionally, the mathematical structure may be used to further analyze and assign scores based on the topology of the network. Additionally, weights may be calculated for each node in the dependency graph, using a weighted dependency impact algorithm. The weights may be assigned to nodes reflect the criticality of each application within the network, based on metrics like application tier and the number of downstream dependencies. For instance, a core service with multiple dependencies might receive a higher weight, indicating a greater potential for impact on the stability of the environment. Various algorithms may be used to determine the weight of the node. In other examples, the weight of the edges rather than the nodes may be calculated. [0001] As an example algorithm, for an environment with ‘n’ applications (corresponding to ‘n’ nodes), a weight may be calculated as: Integer Value*((n*Tier of Application)+No. of Impacted Applications+(2*(impacted application having a change in the same window))/n.

Calculated weights may be propagated across one or more graphs or representations of the environment. For example, weights may be transmitted or calculated for interconnected nodes, assessing how updates might influence related applications. For example, if an update affects a critical application, its weight may be partially distributed to its dependencies, representing the broader impact on the environment. This step allows the system to evaluate cascading effects, offering a holistic view of how updates propagate across the dependency network. This may be performed using neural networks, iterative calculations based on connected neural networks, or other graph based techniques. In some examples, block 304 may be performed automatically when a change to the environment is detected or occur periodically.

At block 306, a presentation is output on a user interface of the first application and each of the one or more linked applications. For example, dashboard 160 may visualize a dependency graph, providing users or operators with a real-time or otherwise updated overview of interconnected applications within the environment. The dashboard 160 may include a presentation that features a central object representing the primary application of interest, surrounded by peripheral objects that denote connected applications.

At block 308, a request to update an element of the first application is received. An update may represent changes, modifications, or adjustments within the environment. For example, update may include changing an element in an application, software version changes, configuration adjustments, or scheduled maintenance activities. Each update may impact one or more applications and influence the dependencies within the application graph.

At block 310, the presentation is updated based on the request. For example, changes to the environment may cause the representation of the network environment (e.g., the application graph 150) to be updated. The dashboard 160 may visualize a recalculated dependency graph, providing users or operators with a real-time or otherwise updated overview of the environment's 102 stability. For instance, when a new change request is submitted, the dashboard may automatically display the predicted impact on connected nodes, allowing operators to assess the potential consequences before implementing the change. The dashboard may further support “what-if” scenarios by enabling operators to simulate changes and observe potential impacts on the graph. This capability may assist in planning and risk management, as operators can proactively evaluate various deployment strategies and their implications. The dashboard 160 may feature alerting and notification capabilities to ensure that relevant users, operators, or entities are informed about ongoing changes. The system may be configured to send automated alerts to users or entities associated with applications affected by a particular change. As an example, the alerts may include key details such as the update source, affected nodes, and estimated resolution time, helping teams prepare for potential disruptions.

At block 312, the first application and the one or more linked applications are updated based on the updated presentation. The analysis module 140 can facilitate real-time updates to the application graph. This dynamic updating process may involve implementing the update to the first application and then re-mapping between affected applications or all applications within a neural network. The update may correspond to the recalculated dependency graph from block 310.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A computing device comprising:
a processor; and
a non-transitory computer-readable medium comprising instructions that are executable by the processor to cause the processor to:
identify a first application;
identify trickle linkages between the first application and each of one or more linked applications;
output a presentation on a user interface of the first application and each of the one or more linked applications;
receive a request to update an element of the first application;
update the presentation of the first application and the trickle linkages based at least in part on the request; and
update the first application and the one or more linked applications based at least in part on the updated presentation.

2. The computing device of claim 1, wherein the update to the first application impacts an element of the one or more linked applications.

3. The computing device of claim 2, the instructions further causing the processor to update each of the one or more linked applications based at least in part on the update to the element of the first application.

4. The computing device of claim 1, wherein the presentation on the user interface comprises:
an object representing the first application;
one or more objects representing the one or more linked applications; and
a linkage representation indicating links between the linked applications and the first application.

5. The computing device of claim 1, the instructions further causing the processor to receive an interaction with the user interface wherein the interaction comprises a selection of a second application from the one or more linked applications different from the first application, and wherein the instructions further cause the processor to output a presentation on the user interface of:
a second object representing the second application; and
a linkage representation indicating links between the linked applications and the second application.

6. The computing device of claim 1, the instructions further cause the processor to:
identify a second application;
identify trickle linkages between the second application and each of the one or more linked applications;
output a presentation on a user interface of the second application and each of the one or more linked applications; and
update the presentation of the trickle linkages based at least in part on received interactions with the user interface or changes in the one or more linked applications.

7. The computing device of claim 1, wherein identifying the trickle linkages between the first application and each of the one or more linked applications is determined by detecting data being pushed from one or more linked applications to or from the first application by an Application Programing Interface (API).

8. A computer implemented method comprising:
identifying a first application;
identifying trickle linkages between the first application and each of one or more linked applications;
outputting a presentation on a user interface of the first application and each of the one or more linked applications;
receiving a request to update an element of the first application;
updating the presentation of the first application and the trickle linkages based at least in part on the request; and
updating the first application and the one or more linked applications based at least in part on the updated presentation.

9. The computer implemented method of claim 8, wherein the update to the first application impacts an element of the one or more linked applications.

10. The computer implemented method of claim 9, further comprising updating each of the one or more linked applications based at least in part on the update to the element of the first application.

11. The computer implemented method of claim 8, wherein the presentation on the user interface comprises:
an object representing the first application;
one or more objects representing the one or more linked applications; and
a linkage representation indicating links between the linked applications and the first application.

12. The computer implemented method of claim 8, further comprising:
receiving an interaction with the user interface wherein the interaction comprises a selection of a second application from the one or more linked applications different from the first application; and
presenting on the user interface:
a second object representing the second application; and
a linkage representation indicating links between the linked applications and the second application.

13. The computer implemented method of claim 8, further comprising:
identifying a second application;
identifying trickle linkages between the second application and each of the one or more linked applications;
outputting a presentation on a user interface of the second application and each of the one or more linked applications; and
updating the presentation of the trickle linkages based at least in part on received interactions with the user interface or changes in the one or more linked applications.

14. The computer implemented method of claim 8, wherein identifying the trickle linkages between the first application and each of the one or more linked applications is determined by detecting data being pushed from one or more linked applications to or from the first application by an Application Programing Interface (API).

15. A non-transitory computer-readable medium comprising instructions that are executable by a processor for causing the processor to:
identify a first application;
identify trickle linkages between the first application and each of one or more linked applications;
output a presentation on a user interface of the first application and each of the one or more linked applications;
receive a request to update an element of the first application;
update the presentation of the first application and the trickle linkages based at least in part on the request; and
update the first application and the one or more linked applications based at least in part on the updated presentation.

16. The non-transitory computer-readable medium of claim 15, wherein the update to the first application impacts an element of the one or more linked applications.

17. The non-transitory computer-readable medium of claim 16, wherein the instructions are further executable by the processor to cause the processor to update each of the one or more linked applications based at least in part on the update to the element of the first application.

18. The non-transitory computer-readable medium of claim 15, wherein the presentation on the user interface comprises:
an object representing the first application;
one or more objects representing the one or more linked applications; and
a linkage representation indicating links between the linked applications and the first application.

19. The non-transitory computer-readable medium of claim 15, wherein the instructions are further executable by the processor to receive an interaction with the user interface wherein the interaction comprises a selection of a second application from the one or more linked applications different from the first application, and wherein the instructions further cause the processor to output a presentation on the user interface of:
a second object representing the second application; and
a linkage representation indicating links between the linked applications and the second application.

20. The non-transitory computer-readable medium of claim 15, wherein the instructions are further executable by the processor to:
identify a second application;
identify trickle linkages between the second application and each of the one or more linked applications;
output a presentation on a user interface of the second application and each of the one or more linked applications; and
update the presentation of the trickle linkages based at least in part on received interactions with the user interface or changes in the one or more linked applications.
